(19) United States
(12) Patent Application Publication
(10) Pub. No.: US 2018/0360001 A1
(43) Pub. Date: Dec. 20, 2018

(54) Automatic Chicken Waterer

(71) Applicant: Ryan Joseph Connolly, Woodland, CA (US)

(72) Inventor: Ryan Joseph Connolly, Woodland, CA (US)

(21) Appl. No.: 15/623,873

(22) Filed: Jun. 15, 2017

(51) Int. Cl. A01K 39/026; A01K 39/02; A01K 39/024

(52) U.S. Cl. CPC A01K 39/026; A01K 39/024; A01K 39/0213

(57) ABSTRACT

The present invention is an automatic chicken waterer within the pet feeding and watering field of inventions. The present chicken waterer is an improvement on automatic chicken waterers by enclosing the water inside a vertical reservoir, and automatically refilling the small volume with a commercially sourced combination float/fill valve that is connection directly to a pressure source. Water is automatically maintained inside the enclosed vertical reservoir by the construction of the assembly0′-. Simplicity in this invention is the compact package construction, with a connection to a constant pressure source, without additional pressure regulation or flow control components. The relatively small reservoir is plumbed to feed multiple poultry nipples spaced sufficiently to allow multiple users concurrently. The semi sealed, frequently refilled reservoir provides fresh and hygienic water to users

### CROSS REFERENCE TO RELATED APPLICATIONS

N/A

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM LISTING COMPACT DISC APPENDIX

N/A

### BACKGROUND OF THE INVENTION

Water storage and dispensing systems for chicken or poultry rely on manual filling and maintenance. Currently market available watering systems rely on large manually filled reservoirs, or automatically refilled open trays allowing fecal and bedding contamination.

Presently there is no solution for directly pressure fed automatic water level sensing and replenishment consisting of a closed, small volume. The invention is system designed to maintain clean hygienic water for poultry

### BRIEF SUMMARY OF THE INVENTION

The present invention seeks to provide an enclosed, automatically refilling, constant pressure supply and gravity feed distribution system for multiple users to drink from simultaneously. A compact reservoir containing level maintenance and fill valve is directly coupled to a distribution manifold with multiple drinking taps for simultaneous use.

Pressurized fluid is connected via adapted connection at bottom of reservoir into the lower end of an integral fill valve. The combination level maintenance/filling valve remains sealed until water level inside reservoir drops below preset adjustable level. Once level gets below set point, the fill valve will open allowing fluid to fill reservoir, refilling reservoir until upper level is achieved. Upper level is also adjustable within level fill valve. The reservoir outlet gravity feeds a distribution manifold coupled to reservoir, with multiple taps for user. Each tap is a positive check tap that requires user to activate tap to release water for user drinking. Multiple taps spaced to allow multiple users simultaneously. Taps are poultry nipples of commercial design and origin

### BRIEF DESCRIPTION OF THE DRAWING

FIG. 1—Pictorial Drawing of Automatic Chicken Waterer Assembly Front View

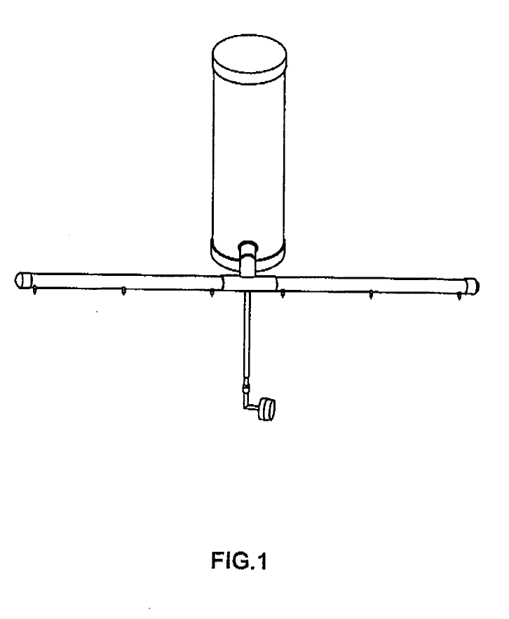

FIG. 2—Pictorial Drawing of Automatic Chicken Waterer Assembly Rear View

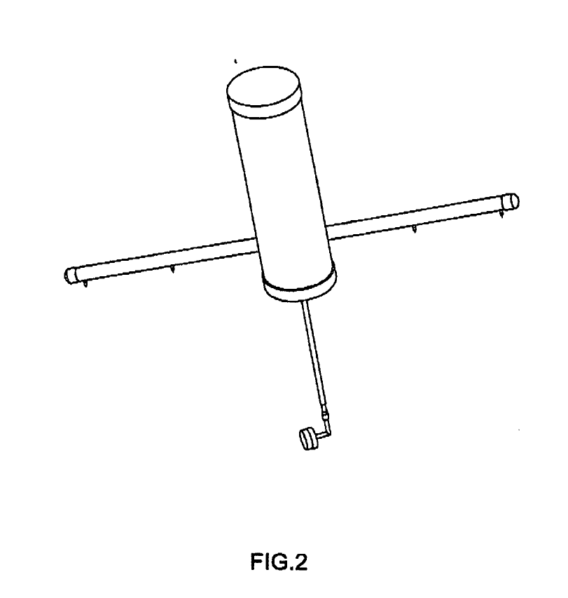

FIG. 3—Detail Assembly Drawing of Automatic Chicken Waterer

FIG. 4—Exploded Diagram of Automatic Chicken Waterer including Part Numbers

### DETAILED DESCRIPTION OF THE INVENTION

The present invention consists of an automatic water level regulating reservoir and distribution manifold. The entire assembly is supported by its own rigid PVC composition. The assembly is mounted with different hardware configurations allowing mounting to flat surfaces such as walls or doors, as well as perforated surfaces like fences or cages.

Accordingly the principal objective of the invention is to provide an improved automatic chicken waterer allowing direct connection to pressurized water source, self regulating level and replenishing the water reservoir automatically.

It is further an objective of the invention to maintain a relatively small volume of water in a semi-sealed vessel to prevent contamination from outside environment.

It is further the objective of the invention to self-regulate level and filling function with prefabricated plumbing components.

An additional object of the invention is to provide an improved automatic chicken waterer and fabricated components of, may be formed of polyvinyl chloride or other suitable plastic material.

It is and object of the invention to automatically fill, maintain, and distribute water to multiple outlets consecutively in a durable, rugged, compact, semi sealed package.

The automatic chicken waterer will consist of commercially produced PVC components, chemically and mechanically assembled to create a sealed water reservoir and distribution manifold.

PVC components allow end user to repair in case of damage or degradation, and increase repeatability and performance of assembly

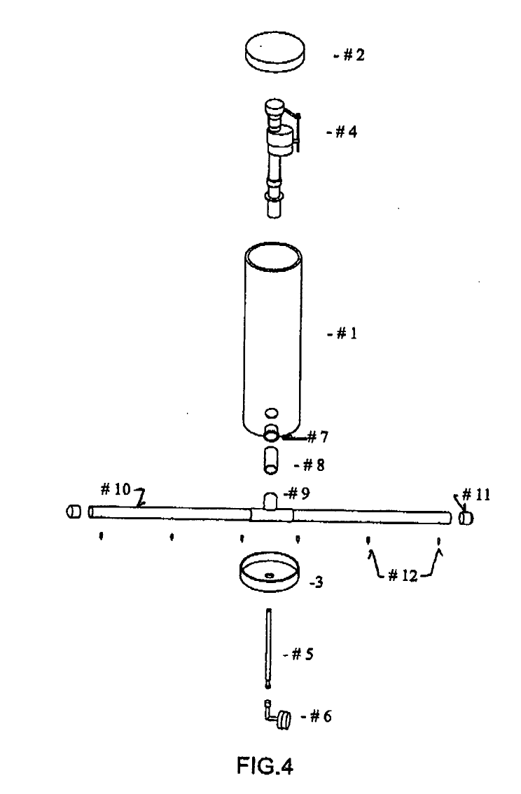

As shown in FIG. 4 Part #3—The body of the reservoir consists of standard large diameter opaque white PVC pipe of nominal length.

As shown in FIG. 4 Part #10—The bottom end of the reservoir is sealed with chemically bonded cap

The bottom end of the reservoir is drilled to accept a commercially available toilet fill/level control valve.

The hole drilled in the lower cap of the reservoir will be spaced to ensure free float and operation of toilet fill valve.

As shown in FIG. 4 Part #2/11/12—The fill/level control valve will be directly coupled with commercially sourced fill hose and adapter to accept a standard male end of garden hose

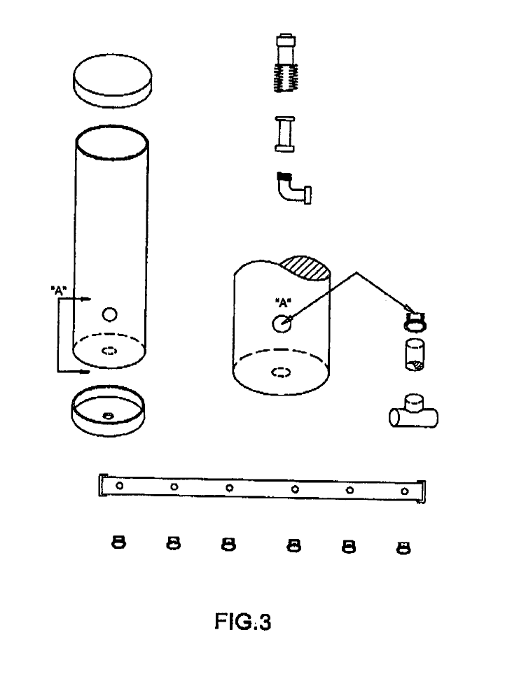

As shown in FIG. 3 and FIG. 4—The lower portion of the vertical reservoir will be drilled to accept a mechanically coupled outlet fitting of tubular PVC—Part #4

As shown in FIG. 3 and FIG. 4 Part #6—The outlet from the reservoir will be split in a tee configuration, 180 degrees from each other

As shown in FIG. 4 Part #7—The outlet will extend using tubular PVC drilled and tapped to accept multiple drinking taps of commercial design

As shown in FIG. 4 Part #9—Outlets will extend from bottom of outlet manifold, sufficiently spaced to allow multiple users to drink concurrently

The reservoir will be drilled near the top with a nominally sized hole as a combination overflow outlet and vent connection to ensure neutral pressure inside reservoir.

### PARTS LIST

1—Top Cap—4″ Test Tite Test Cap
2—Combination Fill/Level valve—Fluidmaster 400A Toilet Fill Valve
3—Reservoir—12″ of 4″ PVC DVW SCH40 Pipe
4—¾ PVC sch40 MIPxS Male Adapter
5—¾″ Tubular PVC—2″ long
6—¾″ Slip PVC Tee Garden
7—¾″ Tubular PVC 12″ long
8—¾″ Slip PVC Cap
9—⅛″ NPT Male Chicken Nipples
10—Bottom Cap—4″ Test Tite Test Cap
11—Adapter Hose—⅞″ ballcock to ⅜ Compression fitting 9″ long—Toilet Fill Line
12—Hose Adapter—⅜″ Compression to ¾ FHT connector

1. The automatic chicken waterer comprising of:
a. A general vertical cylindrical reservoir including a float type fill valve, with an outlet on the lower end with multiple outlets for simultaneous use by multiple users

2. The automatic chicken waterer according to claim 1;
a. The outlet manifold will be directly coupled to lower end of cylindrical fluid reservoir

3. The automatic chicken waterer according to claim 1;
a. Is comprised of Poly Vinyl Chloride Pipe and mated tubular PVC pipe and fittings.

4. The automatic chicken waterer according to claim 1;
a. Includes a reservoir fitted with sealed PVC lower cap, and a tight fitting PVC top cover for protection of insects, dirt, and foreign contaminants.

5. The automatic chicken waterer according to claim 1;
a. All tubular PVC components are comprised of opaque PVC

6. The automatic chicken waterer according to claim 1:
a. The vertical reservoir shall be drilled to accept and fitted with a toilet tank filling valve of commercial design.

7. The automatic chicken waterer according to claim 1:
a. The fill valve/float assembly shall be directly connected to pressurized fluid source

8. The automatic chicken waterer according to claim 1:
a. The vertical reservoir shall be drilled for air vent/overflow level protection

9. The automatic chicken waterer according to claim 2;
a. The outlet manifold is formed as a Tee connection at 90 degree angles from centerline vertical axis of reservoir tank.

10. The automatic chicken waterer according to claim 2;
a. The outlet manifold is to be gravity fed from level maintained in fluid reservoir

11. The automatic chicken waterer according to claim 2;
a. The outlet manifold shall have multiple outlets for simultaneous drinking by multiple users.

12. The automatic chicken waterer according to claim 2;
a. The outlet manifold is to be comprised of rigid supply piping with multiple outlets for simultaneous use

13. The automatic chicken waterer according to claim 11;
a. The outlet manifold is fitted with at least one poultry feeding nipple mechanically coupled

14. The automatic chicken waterer according to claim 11;
a. The fitted poultry feeding nipples are to be mechanically coupled to outlet manifold spaced sufficiently to allow multiple users.
